(19) United States
(12) Patent Application Publication
(10) Pub. No.: US 2003/0015862 A1
(43) Pub. Date: Jan. 23, 2003

(54) Side curtain airbag module

(76) Inventor: Markus Jost, Florsheim (DE)

Correspondence Address: BREED AUTOMOTIVE TECHNOLOGY, INC, 5300 ALLEN K BREED HIGHWAY, P O BOX 33050, LAKELAND, FL, 33807-3050, US

(21) Appl. No.: 10/146,941

(22) Filed: May 17, 2002

(30) Foreign Application Priority Data
Jul. 17, 2001 (DE) 101 34 802.9

(51) Int. Cl. B60R 21/22

(52) U.S. Cl. 280/730.2

(57) ABSTRACT

A side curtain airbag module has an airbag that when folded is arranged essentially along a region of a vehicle roof, and at least one holding strip arranged such that it extends from the vehicle roof in an essentially transverse manner to the longitudinal extension of the folded airbag. The airbag unfolds between the holding strip and an inner side of the vehicle.

### FIELD OF THE INVENTION

The present invention relates to a side curtain airbag module.

### BACKGROUND OF THE INVENTION

Side curtain airbag modules are side airbag modules, in which an airbag in its unfolded state extends downwards laterally from a roof beam into the vehicle interior. The unfolded airbag thereby extends essentially over the entire length of the vehicle, preferably from an A pillar to a C pillar along the inner side of the vehicle. Lateral protection is provided for a vehicle occupant, whereby the airbag extends essentially between the head of a vehicle occupant and the vehicle inner side, i.e. in particular a vehicle side windowpane.

The problem arises with these types of side curtain airbag modules, that the airbag in its unfolded state is not sufficiently secured at its lower end. The risk is thus that, in the event of a crash, the vehicle occupant gets caught between airbag and vehicle inner side, so that the airbag cannot provide sufficient protection for a vehicle occupant. To solve this problem, a tightening device was described in EP 1 059 209 A2, for instance, which secures or tensions the airbag in the region of its lower end. To this effect a tightening cord is used, which is deflected around deflection elements several times and tensions itself during the unfolding of the airbag, to secure the latter in the region of its lower ends. This arrangement is very costly, since various deflection points must be foreseen in the vehicle and on the airbag. This increases manufacturing and assembly costs for the airbag module and involves additional source of error, which jeopardise a secure unfolding of the airbag.

### SUMMARY OF THE INVENTION

In the side curtain airbag module according to the invention, an airbag is arranged in its folded or bundled up state essentially along a region of a vehicle roof. The folded airbag is preferably arranged along a lateral roof beam, so that it extends preferably from an A pillar to a C pillar of the vehicle. In a crash the airbag is inflated with gas and unfolds from the vehicle roof. The unfolding direction of the airbag is in this case essentially downward, so that the inflated or unfolded airbag extends laterally into the vehicle interior essentially parallel to the inner side of the vehicle. In addition the airbag module according to the invention comprises at least one holding strip, which can be arranged in the vehicle such that it extends from the vehicle roof essentially transverse to the longitudinal extension of the folded airbag. The extension direction of the holding strip thus corresponds essentially to the unfolding direction of the airbag. The holding strip can be secured to an inner side of the vehicle at a distance from the vehicle roof. The holding strip is thus secured on the one hand in the region of the vehicle roof and on the other hand to the vehicle inner side, preferably to a lateral body part. The holding strip is arranged in such a manner that the airbag, when it is inflated, can unfold between holding strip and vehicle inner side. The length of the holding strip is preferably selected so that the airbag in its unfolded or inflated state lies tightly against the holding strip. The airbag is clamped between the inner side of the vehicle and the holding strip, so that the airbag is secured to the vehicle side by the holding strip.

### BRIEF DESCRIPTION OF THE DRAWINGS

FIG. 1 is a side view of a side curtain airbag module according to the invention.

FIG. 2 is a sectional view of the folded airbag and holding strip in a resting position.

FIG. 3 is a sectional view of a further embodiment with a common fastening point for the airbag and the holding strip.

FIG. 4 is a sectional view of the unfolded airbag with a holding strip.

FIG. 5 is a sectional view of an alternative embodiment of the unfolded airbag with a holding strip.

### DETAILED DESCRIPTION OF THE INVENTION

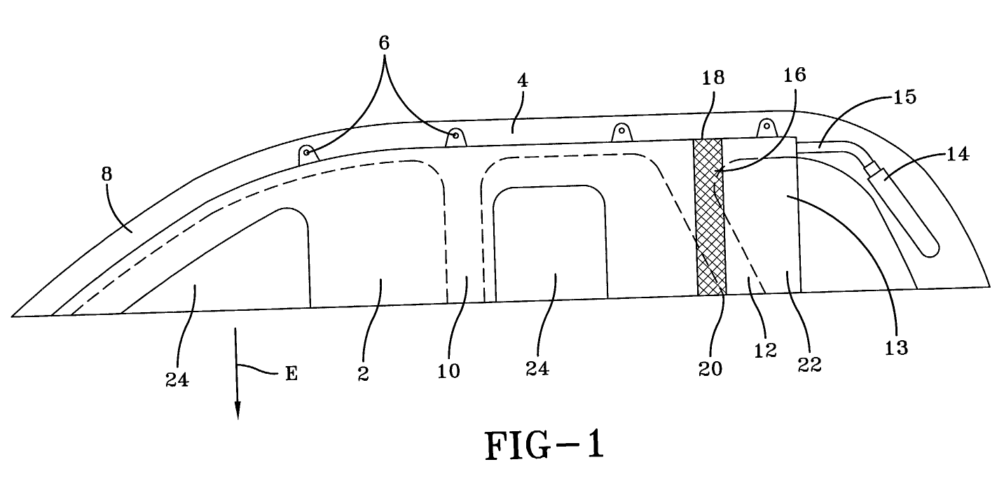

In FIG. 1 a side curtain airbag 2 is shown in its unfolded, i.e. inflated or deployed state. The airbag 2 extends from a lateral roof region or roof beam 4 of a motor vehicle. An upper edge of the airbag 2 is secured at fastening points 6 on the roof beam 4. The unfolded airbag 2 extends essentially parallel to, and along, the roof beam 4, from an A pillar 8 of the vehicle, past a B pillar 10 of the vehicle to the region of a C pillar 12 of the vehicle. As used herein and in the claims the term “A pillar” refers to a roof supporting pillar that is adjacent to the windshield of at vehicle on a lateral side of the vehicle. As used herein and in the claims the term “B pillar” refers to a roof supporting pillar that is located intermittent of the windshield and rear window of a vehicle on a lateral side of the vehicle. As used herein and in the claims the term “C pillar” refers to a roof supporting pillar that is located rearward of the B pillar on a lateral side of the vehicle. At its rear end 13, i.e. the rear end with respect to the front end of the vehicle, the airbag 2 is connected to a source of inflation gas such as a gas generator 14 by a gas supply line 15.

In the region of the C pillar 12 a holding strip 16 is arranged. The holding strip extends essentially transversely or perpendicularly downwards from the roof beam 4. The holding strip 16 is in this case secured at its upper edge 18 to the roof beam 4. The lower end 20 of the holding strip 16 is secured to the C pillar 12 in the unfolding direction E at a distance from the roof beam 4. The fastening point of the lower end 20 of the holding strip 16 on the C pillar 12 is distanced from the roof beam 4 to the extent that the distance between the roof beam 4 and the lower end 20 of the holding strip 16 corresponds essentially to the extension of the unfolded airbag 2 in the unfolding direction E of the airbag. Such an arrangement has the advantage that the fastening point is arranged in the proximity of the lower end of the unfolded or inflated airbag, so that this end of the airbag can be safely secured to the vehicle side. The unfolded airbag 2 lies between the holding strip 16 and the vehicle interior structure, i.e. in particular the vehicle interior trim. A rear portion 13 of the airbag is in this case secured between the holding strip 16 and the C pillar 12. The length of the holding strip 16 is selected so that the airbag 2 in its inflated or deployed state essentially fills the space between the holding strip 16 and the C pillar 12. The airbag 2 is in this way securely pushed against the inner side of the holding strip 16, whereby it is secured to the holding strip in a non-interlocking contact fit due to the friction between the airbag 2 and the holding strip 16. The airbag is preferably secured to the holding strip with a non-interlocking contact fit. In addition, engagement elements can be provided on the airbag and the holding strip, which ensure an interlocking between airbag and holding strip. The holding strip can for instance be roughened. The holding strip is preferably made out of synthetic material in the form of a fabric strip. Other materials, however, in particular fabrics, can be used. A fastening thus takes place also in a horizontal direction, i.e. perpendicular to the unfolding direction E, so that the airbag cannot slip on the holding strip 16. For an improved fastening, corresponding engagement elements can be provided in addition on the holding strip 16 and/or the airbag 2, enabling an engagement between the holding strip 16 and the airbag 2. Since the lower end 20 of the holding strip 16 is secured to the C pillar 12, the airbag 2 in the region of its lower edge 22 is also safely secured to the C pillar 12 when deployed. The airbag 2 shown here comprises additional tucks, or darts, 24 that are not inflated with gas.

Even if in FIG. 1 the arrangement of the holding strip 16 is shown in the region of a C pillar 12 of a vehicle, the arrangement of the holding strip 16 according to the invention is also additionally or alternatively possible in the region of a B pillar 10 or on another suitable side part of a motor vehicle.

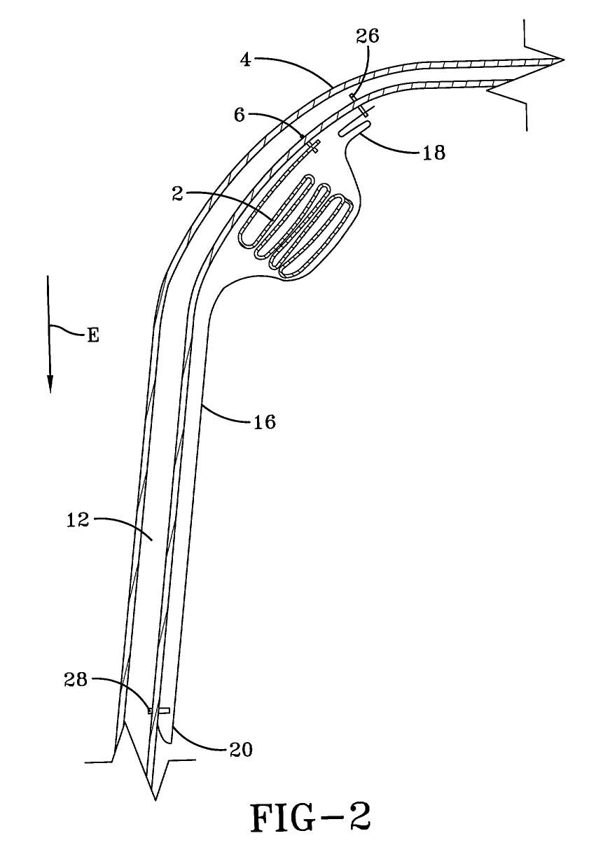

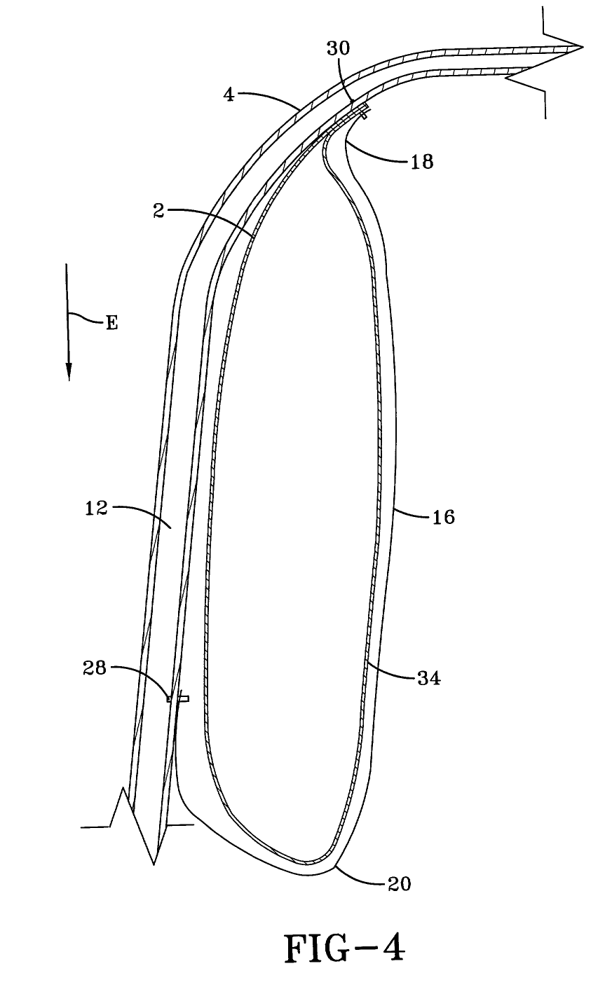

FIG. 2 is a side view of the folded airbag 2 in an undeployed and uninflated state with the holding strip 16. In the region of a roof beam 4, i.e. essentially in the region of the transition from vehicle side to vehicle roof, the airbag 2 is connected to the vehicle body via the fastening point 6. The airbag is folded in such a manner that it forms a parcel that is arranged essentially beneath and along the roof beam 4. The holding strip 16 extends on the inner side of the vehicle body essentially parallel to a roof supporting pillar 12, for instance the C pillar of a motor vehicle. The holding strip 16 is secured at its upper edge 18 by a fastener 26 to the vehicle body, i.e. in particular to the roof beam 4. This fastener, like the fastening of the airbag 2, can be carried out at the fastening points 6, for instance by screws, rivets or clips arrangements. The lower end 20 of the holding strip 16 is connected at a fastening point 28 to the roof supporting pillar 12. The fastening point 28 is essentially distanced from the fastening points 6 and 26 to the extent that the distance essentially corresponds to the extent of the unfolded airbag 2 in its unfolding direction E. In the folded state of the airbag 2 the holding strip 16 lies essentially against the roof supporting pillar 12, whereby it can for instance be arranged below a vehicle interior trim (not represented). The tearing open of the interior trim and emergence of the holding strip can occur due to the force created by the airbag during its unfolding. When the airbag is inflated with gas, it expands and also tensions the surrounding holding strip, so that the latter is pulled or ripped out of the vehicle interior trim, so that the airbag can unfold into the space between the holding strip and the vehicle interior trim. The holding strip continues via the parcel of the folded airbag 2 to the fastening point 26. The holding strip therefore lies close to the vehicle or body inner side and the folded airbag 2. In the unfolded state the airbag 2, extends between the holding strip 16 and the roof beam 12, as shown in FIG. 4.

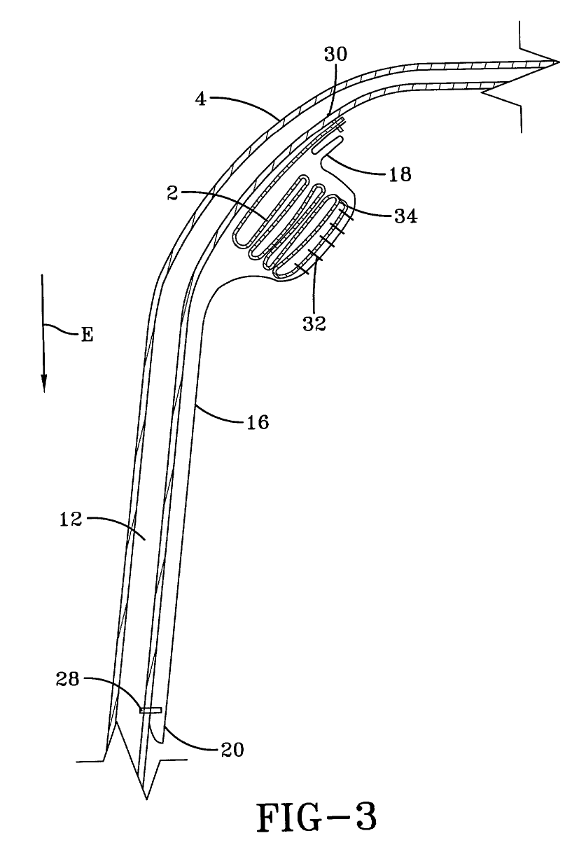

FIG. 3 is an alternative embodiment to the arrangement shown in FIG. 2. The arrangement according to FIG. 3 differs from the arrangement of FIG. 2 in that the airbag 2 and the holding strip 16 are secured on the vehicle body in the region of the roof beam 4 in a common fastening point 30. This simplifies the assembly of the airbag 2 and the holding strip 16 in the vehicle. In addition the holding strip 16 and the airbag 2 can already be secured to each other in the region of the fastening point 30, before the airbag 2 and the holding strip 16 are then secured to the fastening point 30 in the vehicle. In addition, the holding strip 16 is connected to the airbag 2 in the region of its upper edge 18 by frangible members, such as stitches or threads 32. The frangible members 32 connect the holding strip 16 to a front portion 34 of the airbag. The front portion 34 of the airbag 2 is the portion that in the unfolding direction E during the unfolding of the airbag 2 faces the interior of the vehicle and forms the lower edge 22 of the airbag. Due to this arrangement the holding strip is safely secured during the folded state of the airbag, so that it is not freely movable. In addition, the assembly is simplified, since the holding strip can be secured in a predetermined position to the airbag even before the installation in a vehicle, so that it can be installed into a vehicle together with the airbag. The holding strip is preferably secured to the airbag in close proximity to the vehicle roof. During the unfolding of the airbag, the front portion of the airbag in the unfolding direction moves away from the vehicle roof in a downward direction, whereby this region tears off from the holding strip. The front portion 34 of the airbag 2 therefore lies in the unfolded or inflated state of the airbag 2 in the proximity of the fastening point 28, as shown in FIG. 4. The arrangement of the frangible members 32 is not limited to the embodiment shown in FIG. 3, but it can also be foreseen for example with the embodiment shown in FIG. 2. The frangible members 32 enable simpler and improved arrangement of the holding strip 16 with the folded airbag 2 in a vehicle.

FIG. 4 is a sectional view of the unfolded airbag 2 with the holding strip 16 according to the embodiment of FIG. 3. The unfolded state of the airbag 2 of the embodiment shown in FIG. 2 is essentially identical and differs from FIG. 4 only in terms of the separate fastening points 6 and 26. The inflated, i.e. deployed airbag 2 extends from the roof beam 4 essentially parallel to the latter and the roof supporting pillar 12. The airbag 2 in this case extends between the roof supporting pillar 12 and the holding strip 16, whereby the airbag essentially fills the enclosed space between the roof supporting pillar 12 and holding strip 16. The airbag 2 and the holding strip 16 thus essentially form a non-interlocking contact fit, so that the airbag is secured to the holding strip 16. Alternatively or additionally, a non-interlocking and/or interlocking contact with the roof supporting pillar 12 or a corresponding section of the vehicle inner side can be achieved to secure the airbag 2 to the vehicle inner side or the roof supporting pillar 12. The front portion 34 of the airbag 2 in this case also comes into contact with the holding strip 16 in the region of the lower end 20. The front portion 34 of the airbag 2 is secured adjacent to the roof supporting pillar 12 by the holding strip 16. The front portion 34 of the airbag 2 can thus no longer distance itself from the roof supporting pillar 12 into the interior of the vehicle. This way it is avoided that a vehicle occupant gets caught between the inflated airbag 2 and the inner side of the vehicle, for instance the roof supporting pillar 12 or a side windowpane. The fastening of the holding strip 16 to the fastening point 28 can be carried out for instance by screws, rivets or a clipping arrangement.

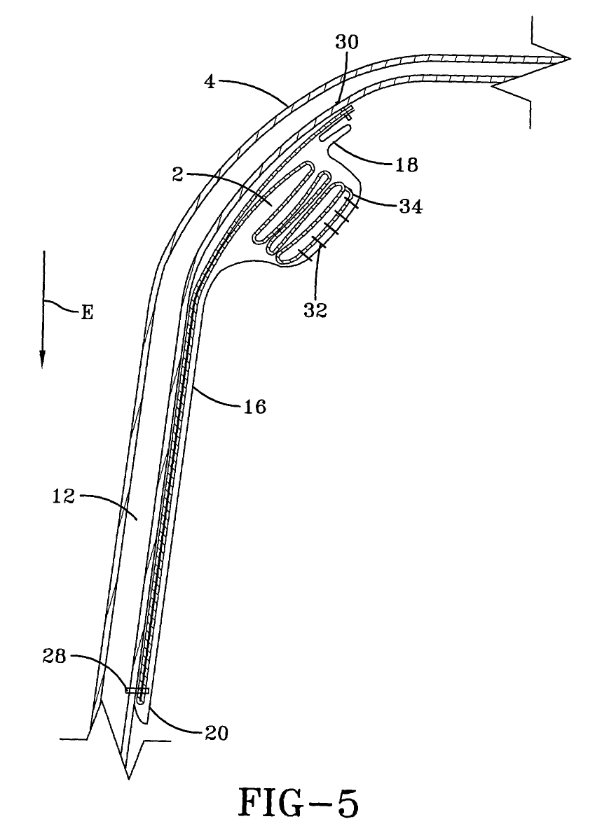

Alternatively to the above shown and described embodiments, in FIG. 5 the holding strip 16 is a closed loop, the two ends of which are connected with the car body to a fastening point 30 on the roof beam 4. Then a region of the loop corresponding to the lower end 20 is connected with the roof supporting pillar 12 at the fastening point 28, so that furthermore a front portion 34 of the airbag 2, which in the unfolded state forms the lower edge 22 of the latter, can be secured to the roof supporting pillar 12 at a distance to the roof beam 4. Since the loop is secured to one side on the vehicle inner side, i.e. to the side turned towards the vehicle outer side, the airbag is thus safely secured to the vehicle inner side. The region of the lower end or the lower edge of the airbag is thus safely secured. The loop is in this case preferably arranged in such a manner that it can be secured to the vehicle inner side to a point in the region of its lower end, i.e. to its end opposite the vehicle roof. Alternatively, the loop can also be secured with an entire side to the vehicle inner side. This can take place in an extensive manner or by several fastening points. In this case, only the side of the loop that is turned towards the vehicle interior remains movable.

Many modifications and changes in the above described embodiment of the invention can, of course, be carried out without departing from the scope thereof. Accordingly, that scope is intended to be limited only by the scope of the appended claims.

I claim:

1. A side curtain airbag module comprising an airbag which in a folded state is arranged essentially along a region of a vehicle roof, and at least one holding strip that is arranged such that the holding strip extends from the vehicle roof essentially transverse to the longitudinal extension of the folded airbag and which, in the unfolding direction of the airbag, can be secured to an inner side of the vehicle at a distance from the vehicle roof, so that the airbag can unfold between the holding strip and the vehicle inner side.

2. The side curtain airbag module according to claim 1 wherein a first end of the holding strip is secured to the vehicle roof and a second end of the holding strip is secured to the inner side of the vehicle at a distance from the vehicle roof.

3. The side curtain airbag module according to claim 1 wherein the holding strip is a loop, the two ends of which are secured to the vehicle roof, whereby a side of the loop is secured at least to a point on the inner side of the vehicle at a distance from the vehicle roof, so that the airbag unfolds into the loop.

4. The side curtain airbag module according to claim 1 wherein the holding strip is secured to the inner side of the vehicle at a fastening point, at a distance from the vehicle roof that corresponds essentially to the extent of the airbag when the airbag is unfolded.

5. The side curtain airbag module according to claim 1 wherein the airbag and the holding strip are fastened to the vehicle roof at a common fastening point.

6. The side curtain airbag module according to claim 1 wherein the holding strip is arranged beneath an interior trim of the vehicle when the airbag is in the folded state.

7. The side curtain airbag module according to claim 6 wherein the interior trim comprises at least one set breaking point, enabling the ejection of the holding strip during the unfolding of the airbag.

8. The side curtain airbag module according to claim 1 wherein the holding strip is connected to the folded airbag by at least one frangible member that breaks during the unfolding of the airbag.

9. The side curtain airbag module according to claim 1 wherein the holding strip is arranged in the region of a roof supporting pillar of the vehicle.

10. The side curtain airbag module according to claim 9 wherein the holding strip extends essentially parallel to the roof supporting pillar.
